(19) United States
(12) Patent Application Publication
(10) Pub. No.: US 2016/0269949 A1
(43) Pub. Date: Sep. 15, 2016

(54) DOWNLINK INTER-CELL INTERFERENCE DETERMINATION

(71) Applicant: TELEFONAKTIEBOLAGET LM ERICSSON (PUBL), Stockholm (SE)

(72) Inventors: Per Burström, Luleå (SE); Arne Simonsson, Gammelstad (SE); Tomas Jönsson, Luleå (SE); Peter Ökvist, Luleå (SE)

(21) Appl. No.: 15/030,955

(22) PCT Filed: Nov. 8, 2013
(86) PCT No.: PCT/SE2013/051317

§ 371 Date: Apr. 21, 2016

(51) Int. Cl. H04W 36/00; H04W 36/20; H04W 48/12; H04W 36/04

(52) U.S. Cl. CPC H04W 36/0088; H04W 36/04; H04W 36/20; H04W 48/12; H04W 84/045

(57) ABSTRACT

A method in a network node for determining a measure of a downlink interference in a wireless communications network. The downlink interference comprises a first interference in one or more first user equipments in a first cell served by a first base station. The respective interference originates from a second base station when the second base station communicates with one or more second user equipments in a second cell. The network node obtains a first metric representing a count of the second cell as the strongest interfering cell for the one or more first user equipments in the first cell based on a respective information from the one or more first user equipments. The respective information indicates a strongest interfering cell for the respective first user equipment. The network node determines a measure of the downlink interference, based on the first metric.

### TECHNICAL FIELD

Embodiments herein relate to a network node, a first user equipment and methods therein. In particular, it relates to interference in a wireless communications network.

### BACKGROUND

Communication devices such as User Equipments (UE) are also known as e.g. mobile terminals, wireless terminals and/or mobile stations. User equipments are enabled to communicate wirelessly in a wireless communications network, sometimes also referred to as a wireless communication system, a cellular communications network, a cellular radio system or a cellular network. The communication may be performed e.g. between two user equipments, between a user equipment and a regular telephone and/or between a user equipment and a server via a Radio Access Network (RAN) and possibly one or more core networks, comprised within the cellular communications network.

User equipments may further be referred to as mobile telephones, cellular telephones, laptops, or surf plates with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another user equipment or a server.

The wireless communications network covers a geographical area which is divided into cell areas, wherein each cell area is served by a base station, e.g. a Radio Base Station (RBS), which sometimes may be referred to as e.g. “eNB”, “eNodeB”, “NodeB” or “B node” depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the user equipments within range of the base stations. In the context of this disclosure, the expression Downlink (DL) is used for the transmission path from the base station to the user equipment. The expression Uplink (UL) is used for the transmission path in the opposite direction i.e. from the user equipment to the base station.

In some RANs, several base stations may be connected, e.g. by landlines or microwave, to a radio network controller, e.g. a Radio Network Controller (RNC) in Universal Mobile Telecommunications System (UMTS), and/or to each other. The radio network controller may supervise and coordinate various activities of the plural base stations connected thereto.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE is controlled by the radio base station.

Wireless communications networks are becoming more flexible, for example with the use of heterogeneous networks. In a heterogeneous network, in addition to the planned or regular placement of macro base stations, several pico and/or femto and/or relay base stations may be deployed. The power transmitted by these pico and/or femto and/or relay base stations, being up to 2 W, is relatively small compared to that of the macro base stations, up to 40 W. These Low Power Nodes (LPN) are typically deployed to eliminate coverage holes in the homogeneous network using macro base stations only. The LPNs may improve capacity in hot-spots. Due to their low transmit power and small physical size, the pico/femto/relay base stations may offer flexible site acquisitions.

For example, it may be beneficial to let user equipments connect to a pico cell served by the pico base station even though there is a stronger macro cell served by the macro base station. This is at least partly explained by the fact that transmitting with a macro base station causes more downlink interference to the rest of the cells than transmitting from a pico base station, since the macro base station both transmits with higher power and has a higher antenna position reaching over roof tops interfering over a larger area. A problem with the flexible networks is the more complex interference situation.

### SUMMARY

It is therefore an object of embodiments herein to provide a better way of determining the downlink interference in a wireless communications network.

According to a first aspect of embodiments herein, the object is achieved by a method in a network node for determining a measure of a downlink interference in a wireless communications network. The downlink interference comprises a first interference in one or more first user equipments in a first cell served by a first base station. The respective interference in the one or more first user equipments originates from a second base station when the second base station communicates with one or more second user equipments in a second cell. The network node obtains a first metric. The first metric represents a count of the second cell as the strongest interfering cell for the one or more first user equipments in the first cell. The first metric is obtained based on a respective information from the one or more first user equipments in the first cell. The respective information indicates a strongest interfering cell for the respective first user equipment. The network node further determines a measure of the downlink interference, based on the first metric.

According to a second aspect of embodiments herein, the object is achieved by a network node. The network node is configured to determine a measure of a downlink interference in a wireless communications network. The downlink interference comprises a first interference in one or more first user equipments in a first cell arranged to be served by a first base station. The respective interference in the one or more first user equipments originates from a second base station when the second base station communicates with one or more second user equipments in a second cell. The network node comprises an obtaining circuit configured to obtain a first metric. The first metric represents a count of the second cell as the strongest interfering cell for the one or more first user equipments in the first cell. The first metric is obtained based on a respective information from the one or more first user equipments in the first cell. The respective information indicates a strongest interfering cell for the respective first user equipment. The network node further comprises a determining circuit configured to determine a measure of the downlink interference, based on the first metric.

According to a third aspect of embodiments herein, the object is achieved by a method in a first user equipment for assisting a network node in determining a measure of a downlink interference in a wireless communications network. The first user equipment is located in a first cell. Further, the first user equipment communicates with a first base station. The downlink interference comprises an interference in the first user equipment. The downlink interference originates from a second base station when the second base station communicates with one or more second user equipments in a second cell. The first user equipment determines a strongest interfering cell. The first user equipment counts the second cell as the strongest interfering cell for the first user equipment. Further, the first user equipment assists the network node in determining the measure of the downlink interference by providing to the network node an information indicating the second cell as the strongest interfering cell for the first user equipment. The information comprises a result of the counting.

According to a fourth aspect of embodiments herein, the object is achieved by a first user equipment. The first user equipment is configured to assist a network node in determining a measure of a downlink interference in a wireless communications network. The first user equipment is arranged to be located in a first cell. Further, the first user equipment is arranged to communicate with a first base station. The downlink interference comprises an interference in the first user equipment. The downlink interference originates from a second base station when the second base station communicates with one or more second user equipments in a second cell. The first user equipment comprises a determining circuit configured to determine a strongest interfering cell. The first user equipment further comprises a counting circuit configured to count the second cell as the strongest interfering cell for the first user equipment. The first user equipment further comprises a providing circuit configured to assist the base station in determining the measure of the downlink interference by providing to the network node an information indicating the second cell as the strongest interfering cell for the first user equipment. The information comprises the count of the second cell as the strongest interfering cell for the first user equipment.

Since the network node determines a measure of the downlink interference based on the respective information indicating a strongest interfering cell for the respective first user equipment, the network node determines the downlink interference in the wireless communications network in a better way.

An advantage with embodiments herein is that the network node takes into account actual propagation properties of the downlink interference and spatial distribution of the first user equipments when determining the downlink interference associated with the first cell. In this way a better way of determining the downlink interference in the wireless communications network is provided.

A further advantage with embodiments herein is that they provide means for interference balancing between cells. Interference balancing may be implemented by for example pushing user equipments towards cells with low interference impact based on the measure of the downlink interference. This improves the overall spectral efficiency of the wireless communications network.

### BRIEF DESCRIPTION OF THE DRAWINGS

Examples of embodiments herein are described in more detail with reference to attached drawings in which:

FIG. 1 is a schematic block diagram illustrating embodiments of a wireless network.

FIG. 2 is a signaling diagram illustrating embodiments in a wireless network.

FIG. 3 is a signaling diagram illustrating further embodiments in a wireless network.

FIG. 4 is a flowchart depicting embodiments of a method in a network node.

FIG. 5 is a schematic block diagram illustrating embodiments of a network node.

FIG. 6 is a flowchart depicting embodiments of a method in a first user equipment.

FIG. 7 is a schematic block diagram illustrating embodiments of a first user equipment.

### DETAILED DESCRIPTION

As part of developing embodiments herein, a problem will first be identified and discussed.

In wireless communications networks typically each cell operates their radio resource management methods independently from the neighboring cells. The relation to other cells and the spatial distribution of user equipment in other cells is difficult to estimate. The resulting interference caused from a downlink transmission is also difficult to estimate. The gain for the wireless communications network from using available methods of interference reduction in a certain cell is unclear and therefore the available methods are seldom used.

In 3GPP LTE, one downlink interference measurement is standardized, the Relative Narrowband Transmit Power (RNTP) indicator. This is sent to neighboring cells and contains 1 bit per Physical Resource Block (PRB) in the downlink. The RNTP indicates if the transmission power on that PRB will be greater than a given threshold. However, the RNTP does not give any information of the strength of the interference and no information of the source of the interference.

Advanced fast dynamic point selection is studied within the Coordinated Multipoint transmission and reception (CoMP) framework and showing promising results. For CoMP full knowledge of all path loss relations, referred to as a g-matrix, is needed. In general, obtaining full path-loss information is very challenging and costly. In LTE, the user equipment report Reference Signal Received Power (RSRP) for its serving cell and up to six neighbors periodically or upon request by the serving network node. However, due to the user equipments' measurement constraints only neighbors within 6 dB from the strongest cell may be reported. This means that the g-matrix that may be constructed from RSRP measurements will be very sparse and not provide accurate information of the interference situation at any given time.

In embodiments herein a measure of a downlink interference is determined. The measure of the downlink interference may be referred to as an interference cost. The interference cost of the cell represents the adverse effects said cell has on the rest of the network when transmitting to users that it serves. Further, in embodiments herein the measure of the downlink interference is based on a count of the number of occurrences that a certain cell is identified as a strongest interfering cell in the user equipments in an interfered cell. The strongest interfering cell may for example be identified in a list of strongest neighbor cells in the user equipment. If a large number of user equipments report the certain cell as the strongest interfering cell, this is a good indication of the downlink interference from that certain cell.

Such a measure of the downlink interference, or interference cost, may capture the actual interference impact that results from both radio network planning and spatial user distribution. Radio network planning aspects that cause inhomogeneous interference from different cells are for example transmit power, antenna height, antenna gain, feeder loss, antenna direction and tilt. Propagation conditions and antenna interaction may also have large impact; e.g. an antenna pointing along a street may result in line of sight with high antenna gain.

The count of the strongest interfering cell may be provided by the user equipment to the serving base station. Existing measurement reports may be used to provide the count. For example, the information indicating the strongest interfering cell may be comprised in an RSRP report in LTE and a Received Signal Code Power (RSCP) report in WCDMA networks. In LTE, the user equipment sends the RSRP report to their serving cell. The RSRP report contain information about the signal strength of neighboring cells. The RSRP report is used to control handovers between different cells. In embodiments herein such signal strength information may also be used to calculate the downlink interference. RSRP reports are sent over the Radio Resource Control (RRC) layer and are typically triggered according to defined events or sent periodically in a set periodicity. RSRP reports are based on the Cell specific Reference Symbol (CRS) present in 3GPP LTE Rel. 8-11. Channel State Information RSRP (CSI-RSRP) is being discussed for 3GPP LTE Rel. 12. Along with the RSRP, the Physical Cell Identity (PCI) is also sent, enabling identification of which neighbor cell that is measured. One report from the user equipment may contain a number of RSRP measures for several PCIs.

In WCDMA, similarly to LTE, the RSCP measured on the Common Pilot CHannel (CPICH) is sent to the serving cell together with corresponding scrambling code for cell identification. The RSCP is also sent when triggered or periodically.

Further, in embodiments herein a cell parameter, such as a cell-specific Cell-Selection Offset (CSO), used for offsetting a hand-over threshold between cells may be set based on the determined measure of the downlink interference. The CSO determines the handover limits between pairs of network nodes, affects load and interference balancing between nodes and may push users towards nodes with low interference impact. In general, the CSO may improve the spectral efficiency in heterogeneous wireless communications networks. This is also the general case in the downlink where it may be beneficial to let a user equipment connect to a pico cell even though there is a stronger macro cell by which the user equipment may be served. This is at least partly explained by the fact that transmitting with a macro base station causes more interference to the rest of the cells than transmitting from a pico base station, since the macro base station both transmits with higher power and has a higher antenna position reaching over roof tops interfering over a larger area.

In state-of-the-art networks, the CSO is typically set globally for simplicity. Such global fixed CSO for all cell relations is non-optimal since it poorly captures the actual interference situation. The interference depends on several factors that may differ for each cell relation, such as distance between cells, actual propagation conditions of the radio signals and the spatial distribution of the user equipments. Using the cell parameter, such as the cell-specific CSO, may improve the overall spectral efficiency of the wireless communications network.

In general, management or coordination of radio resources in the wireless communications network based on interference is a powerful technique to increase the spectral efficiency in the wireless communications network. If a steering network node, controlling one or multiple cells, knows the amount of interference that transmissions in a neighboring interfering cell cause to one of the user equipment connected to the steering node, the knowledge about the interference may be used for improving the spectral efficiency in the wireless communications network. This is a key technology in CoMP schemes, where multiple access points are interconnected through a fast backhaul to a steering node. CoMP networks are well suited to utilize interference information since centralized and coordinated Radio Resource Management (RRM) algorithms may be used throughout the connected nodes.

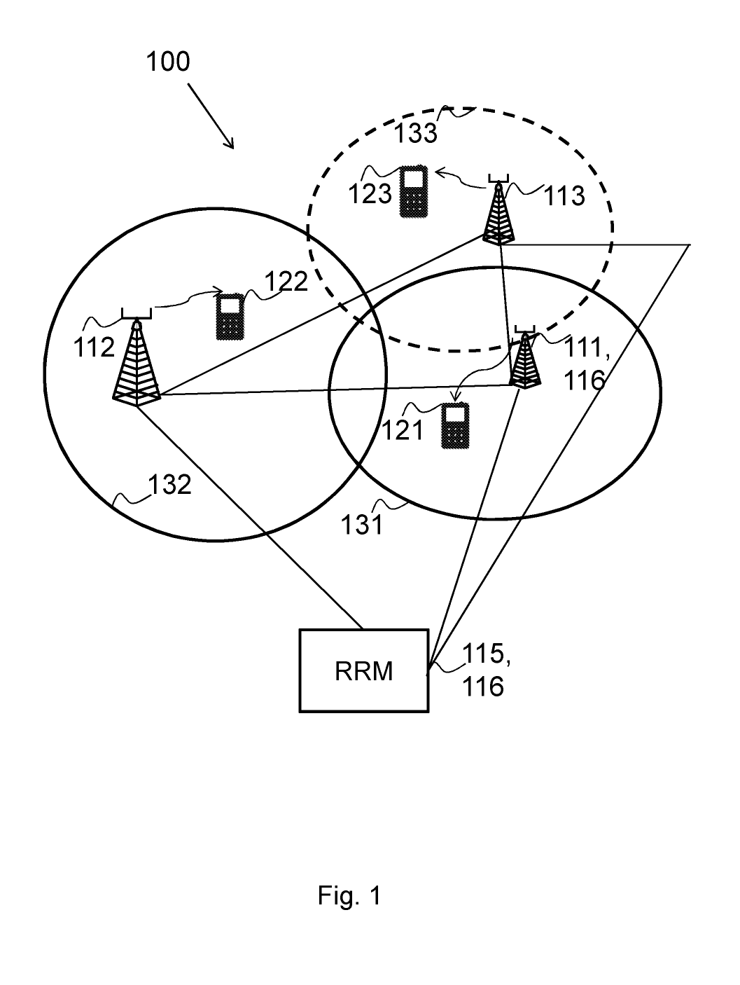

FIG. 1 depicts a wireless communications network 100 in which embodiments herein may be implemented. The wireless communications network 100 may for example be an LTE or a WCDMA network.

The wireless communications network 100 comprises a network node such as a first base station 111. The wireless communications network 100 further comprises a second base station 112. The wireless communications network 100 may further comprise a third base station 113. The base stations may for example be eNBs in an LTE network. The third base station 113 may in some cases be the same base station as the second base station 112.

The wireless communications network 100 may further comprise a central network node 115, which handles coordinated RRM in the network.

Embodiments herein may be performed in any of the base station 111 or the central network node 115. Therefore, when describing the embodiments herein in a general way the base station 111 and the central network node 115 are commonly referred to as a network node 116.

The first base station 111 serves one or more first user equipments 121, while the second base station 112 serves one or more second user equipments 122. The third base station 113 may serve one or more third user equipments 123. The one or more first user equipments 121 are located in a first cell 131, while the one or more second user equipments 122 are located in a second cell 132. The one or more third user equipment 123 may be located in a third cell 133. A communication between the first base station 111 and the respective one or more first user equipments 121 may be performed by radio communication.

The network node 111, 115, 116 communicates with the second base station 112. The network node 111, 115, 116 may further communicate with each of the first and the third base stations 111, 113. The communication between the network node 111, 115, 116 and each base station 111, 112, 113 may be performed by for example landlines or radio communication or a combination thereof.

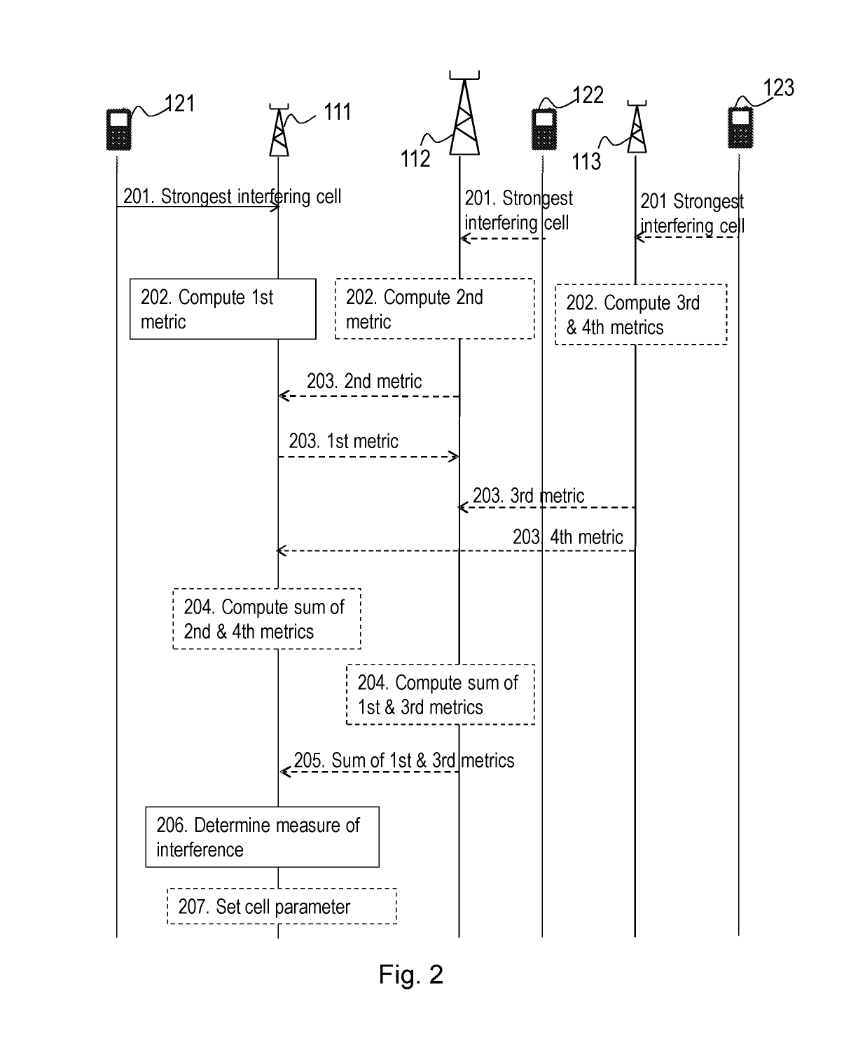

Actions for determining a measure of a downlink interference in a wireless communications network 100 in an example scenario, will now be described with reference to a combined flowchart and signaling diagram depicted in FIG. 2. In this scenario the network node 111, 116 is the first base station 111.

As mentioned above, the first base station 111 serves the one or more first user equipments 121 in the first cell 131.

In a further example scenario the downlink interference comprises a first interference in the one or more first user equipments 121. The respective first interference in the one or more first user equipments 121 originates from the second base station 112 when the second base station 112 communicates with the one or more second user equipments 122 in the second cell 132.

The downlink interference may comprise different parts from different sources. Thus the downlink interference may further comprise a second interference in the one or more second user equipments 122 in the second cell 132. The second interference originates from the first base station 111 when communicating with the one or more first user equipments 121 in the first cell 131.

In some embodiments the downlink interference further comprises a third interference in the one or more third user equipments 123 in the third cell 133, which respective third interference originates from the second base station 112 when communicating with the one or more second user equipments 122 in the second cell 132.

The downlink interference may further comprise a fourth interference in the one or more third user equipments 123 in the third cell 133. The respective fourth interference originates from the first base station 111 when communicating with the one or more first user equipments 121 in the first cell 131.

The actions may be taken in any suitable order. Further, actions may be combined.

Action 201

In order for the network node 111, 116 to compile the information about the interference in the first cell 131, the one or more first user equipments 121 in the first cell 131 may provide to the network node 111, 116 a respective information indicating the strongest interfering cell for the respective first user equipment 121.

Similarly, the one or more second and third user equipments 122, 123 may each provide to the respective second and third base station 112, 113 a respective information indicating the strongest interfering cell for the respective second and third user equipments 122, 123.

Existing measurement reports may be used for this action. For example the information indicating the strongest interfering cell may be comprised in the RSRP reports in LTE and the RSCP reports in WCDMA networks. These reports comprise a signal strength and an identification of interfering cells, e.g. identified by their PCI. Other reports may also be used, for example reports comprising: measurements related to handover, cell traces or user equipment traces initiated by performance monitoring, or system logs. Each base station may collect the available reports from the user equipments that are communicating with the respective base station.

The user equipments, e.g. the one or more first user equipment 121 may also provide information regarding the downlink interference in a specific report which is not standardized today. The specific report may comprise more information than the signal strength and the identity of an interfering cell. For example, the one or more first user equipments 121 may summarize the counts for each interfering cell during a specific time period. The specific time period may for example be the time period during which the one or more first user equipments 121 communicates with the serving first base station 111. In some embodiments the respective one or more first user equipment 121, determines the strongest interfering cell. Then the respective one or more first user equipment 121 counts the second cell 132 as the strongest interfering cell for the first user equipment 121.

Further, in these embodiments the respective one or more first user equipment 121 assists the network node 111, 116 in determining the measure of the downlink interference by providing to the network node 111, 116 an information indicating the second cell 132 as the strongest interfering cell for the first user equipment 121, which information comprises a result of the counting.

The network node 111, 116 may then after obtaining the indication compile the counts for the one or more first user equipments 121 in action 202.

Action 202

When the network node 111, 116 has obtained the indications provided in action 201 the network node 111, 116 computes a first metric representing a count of the second cell 132 as the strongest interfering cell for the one or more first user equipments 121 in the first cell 131 based on the respective information from the one or more first user equipments 121 in the first cell 131. The network node 111, 116 may of course also compute a respective metric for each cell that is identified as the strongest interfering cell in the respective one or more first user equipment 121.

The first metric may be a sum of the number of indications obtained from the one or more first user equipments 121. For example, there may be ten first user equipments 121 that each has provided indications that the second cell 132 is the strongest interfering cell.

In some embodiments the network node 111 computes the first metric by weighting each count of the second cell 132 as the strongest interfering cell with a weight. The weight may correspond to a property of the respective one or more first user equipment 121. The weight may further correspond to a signal power, associated with the interference, in the respective one or more first user equipment 121. For example, the second cell 132 is the strongest interfering cell for one of the first user equipments 121. Said first user equipment 121 measures a signal power of 3 dBm from the second cell. Further, the third cell 133 is the strongest interfering cell for another of the first user equipments 121. The further first user equipment 121 measures a signal power of 6 dBm from the third cell. Then the network node 111, 116 may assign different weights to the respective count associated with the respective first user equipment 111 to account for the difference in measured signal power. Measurement errors and other relevant properties of the first user equipment 121 may also be taken into account when determining the weight.

In this manner, the network node 111, 116 will have information about the downlink interference that each of the cells identified in action 201 causes in the first cell 131.

Correspondingly the second and third base stations 112, 133 may also compute metrics, each representing a respective count of the strongest interfering cell for the one or more second and one or more third user equipments 122, 123 in the respective second and third cells 132, 133 based on the information obtained in action 201. For example, in some embodiments the second base station 112 computes a second metric representing a count of the first cell 131 as the strongest interfering cell for the one or more second user equipments 121 in the second cell 132 based on the information obtained in action 201. Further, the third base station 113 may compute a third metric representing a count of the second cell 132 as the strongest interfering cell for the one or more third user equipments 123 in the third cell 133 based on the information obtained in action 201.

In some embodiments the third base station 113 computes a fourth metric representing a count of the first cell 131 as the strongest interfering cell for the one or more third user equipments 123 in the third cell 133 based on the information obtained in action 201.

Action 203

When the respective base station 111, 112, 113 have computed the respective metrics the respective base station 111, 112, 113 may provide the respective metric to the corresponding interfering network node in order for the interfering node to become aware of its own interference. For example the network node 111, 116 may provide the first metric to the second base station 112. The second base station 112 may provide the second metric to the network node 111, 116. The third base station 113 may provide the third metric to the second base station 112 and the fourth metric to the network node 111, 116.

Action 204

When the first and the second base stations 111, 112 have computed the metrics in action 203 the first and the second base stations 111, 112 may compute a respective sum of the metrics. For example, the second base station 112 may compute a first sum of the first metric and the third metric. The respective sum may represent the downlink interference caused globally by the respective first and second cell 131, 132 in the other cells. For example, the first sum of the first metric and the third metric represents the downlink interference caused globally by the second base station 112 in the first cell 131 and in the third cell 133.

Action 205

Each network node 111, 112, 113 may provide information regarding the downlink interference caused globally by itself to the other network nodes. The information may for example comprise the sums of the metrics computed in action 204. In this way the network node 111, 116 may obtain information from the second base station 112 about the downlink interference caused globally by the second base station 112 in both the first cell 131 and the third cell 133.

Action 206

The network node 111, 116 determines a measure of the downlink interference based at least on the first metric. In the simplest case the determination of the downlink interference may be performed already after action 202. However, the measure of the downlink interference may further be based on the second metric and/or the third metric and/or the fourth metric and/or any sum and/or difference thereof. For example, the determination of the measure of the downlink interference may be based on a difference between the first sum of the first and third metrics and a second sum of the second and fourth metrics. This measure may represent a relative measure of the global downlink interference originating from the first and second cells 131, 132.

Further, the measure of the downlink interference may be normalized. Normalization may be advantageous for example when the network node 111, 116 sets a value of the cell parameter based on the measure of the downlink interference, as in action 207. The normalization may for example be performed over an average measure of the downlink interference in the cells in the wireless communications network 100. The normalization may also be performed over time. The time-wise normalization may be used to track changes due to traffic variations in the network.

Action 207

After the network node 111, 116 has determined the measure of the downlink interference the network node 111, 116 may set the cell parameter used for offsetting a handover threshold between the first cell 131 and the second cell 132. The setting is based on the determined measure of the downlink interference.

Such a handover threshold relating to handover between the first cell and the second cell may be used to control the amount of the one or more first user equipments 121 in the first cell 131 relative to the amount of the one or more second user equipments 121 in the second 132 cell. Therefore the cell parameter may be a tool to control traffic and/or interference in the wireless communications network 100.

The cell parameter may for example be a cell individual offset parameter. A specific cell individual offset parameter that may be set is the CSO. The CSO may be associated to a pair of cells, for example comprising the first cell 131 and the second cell 132. The CSO associated to the pair of cells may be set based on the measure of the downlink interference. For example the CSO may be based on the difference between the first sum of the first and third metric and the second sum of the second and fourth metric.

A function to set the cell parameter may be done in different ways. A step function loop increasing or decreasing the cell parameter between each pair of cells followed by a measuring period may be used.

In some embodiments a linear-to-dB-lookup function changing the cell parameter in dB in correspondence to a relative measure of the downlink interference between two cells, such as the first and the second cells 131, 132, is used to set the cell parameter. E.g. if the second sum is two times higher than the first sum then the network node 111, 116 may increase the value of the cell parameter for the first cell 131 with 3 dB relative to the previously set value of the cell parameter for the first cell 131. This means that the first cell 131 will take up traffic from the second cell 132 since the threshold for the hand-over from the second cell 132 to the first cell 131 is lowered by 3 dB. Suitable coefficients in linear or dB scale may be applied to weight the measures.

In this manner, the network node 111, 116 will have information about the interference that the cells in the wireless communication network 100 causes, also referred to as an interference cost, to all other cells. This enables the network node 111, 116 to adapt to a changing traffic situation on different time scales. In particular, the measure of the downlink interference may be used to adapt a load balancing between cells, such as the first cell 131 and the second cell 132, based on both signal and interference power. The load balancing may be achieved by setting the cell parameter on an individual cell basis, e.g. based on the measure of the downlink interference.

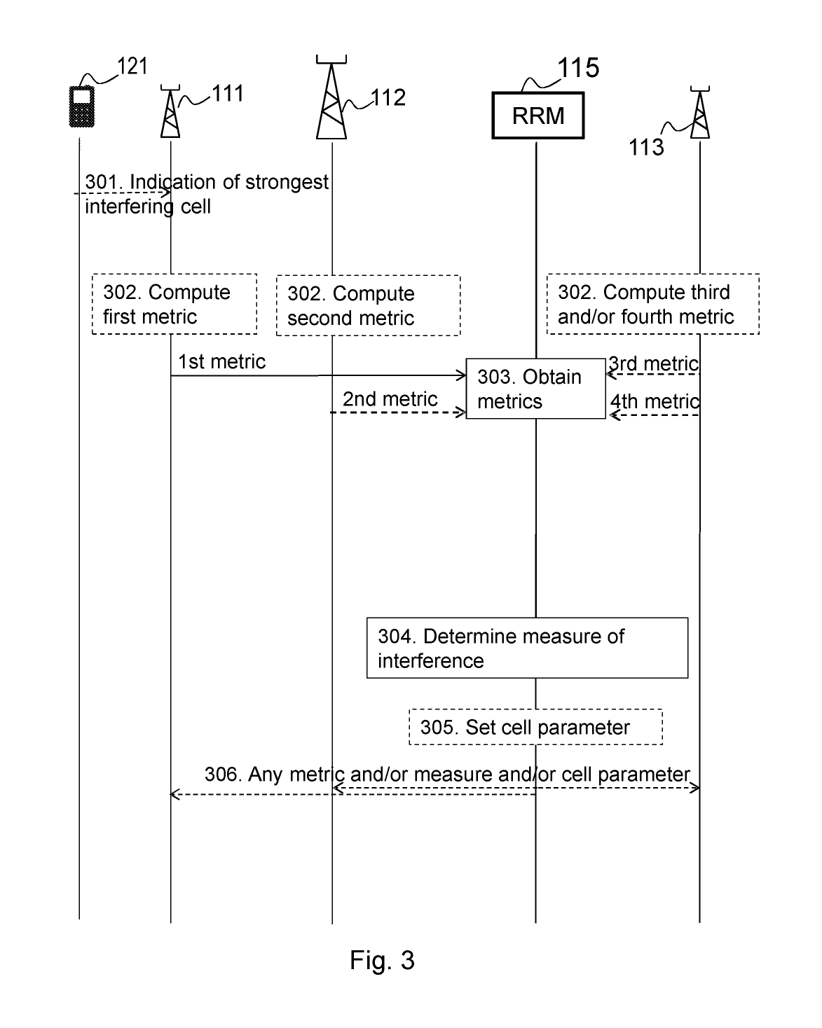

Actions for determining the measure of the downlink interference in a wireless communications network 100 in an alternative scenario, will now be described with reference to a combined flowchart and signaling diagram depicted in FIG. 3. In this scenario the network node 115, 116 is the central network node 115.

As mentioned above in relation to FIG. 1 and FIG. 2, the first base station 111 communicates with the one or more first user equipments 121 in the first cell 131. The downlink interference comprises the first interference in the one or more first user equipments 121.

The downlink interference may further comprise the second interference in the one or more second user equipments 122 in the second cell 132.

In some embodiments the downlink interference further comprises the third interference in the one or more third user equipments 123 in the third cell 133.

The downlink interference may further comprise the fourth interference in the one or more third user equipments 123 in the third cell 133. The method comprises the following actions, which actions may be taken in any suitable order. Further, actions may be combined.

Action 301

In order for the network node 115, 116 to determine the measure of the downlink interference in the wireless communications network 100, the one or more first user equipments 121 in the first cell 131 may provide to the first base station 111 a respective information indicating the strongest interfering cell for the respective first user equipment 121.

Similarly, the one or more second and third user equipments 122, 123 may each provide to the respective second and third base station 112, 113 a respective information indicating the strongest interfering cell for the respective second and third user equipments 122, 123.

Action 302

When the first base station 111 has obtained the indications provided in action 301 the first base station 111 may compute the first metric representing the count of the second cell 132 as the strongest interfering cell for the one or more first user equipments 121 in the first cell 131 based on the obtained information.

Correspondingly the second base station 112 may compute the second metric and the third base station 113 may compute the third and fourth metrics.

Action 303

The first base station 111 provides the first metric to the network node 115, 116. The first metric represents the count of the second cell 132 as the strongest interfering cell for the one or more first user equipments 121 in the first cell 131.

The second base station 112 may provide the second metric to the network node 115, 116. The second metric represents the count of the first cell 131 as the strongest interfering cell for the one or more second user equipments 122 in the second cell 132.

The third base station 113 may provide the third metric to the network node 115, 116. The third metric represents the count of the second cell 132 as the strongest interfering cell for the one or more third user equipments 123 in the third cell 133.

The third base station 113 may provide the fourth metric to the network node 115, 116. The fourth metric represents the count of the first cell 131 as the strongest interfering cell for the one or more third user equipments 123 in the third cell 133.

Action 304

The network node 115, 116 determines the measure of the downlink interference, at least based on the first metric.

The network node 115, 116 may determine the measure of the downlink interference further based on the second metric.

In some embodiments the network node 115, 116 determines the measure of the downlink interference further based on the third metric.

The network node 115, 116 may further determine the measure of the downlink interference based on the fourth metric.

Further, the network node 115, 116 may determine the measure of the downlink interference based on any sum and/or difference of the metrics. For example, the measure of the downlink interference may be based on the difference between the first sum of the first and third metric and the second sum of the second and fourth metric.

Further, the measure of the downlink interference may be normalized.

Action 305

After the network node 115, 116 has determined the measure of the downlink interference the network node 115, 116 may set a cell parameter used for offsetting a hand-over threshold between the first cell 131 and the second cell 132. The setting is based on the determined measure of the downlink interference.

Action 306

In some embodiments the network node 115, 116 provides to any of the first, second and third base stations 111, 112, 113 any one of the metrics.

The network node 115, 116 may further provide to any of the first, second and third base stations 111, 112, 113 the measure of the downlink interference.

In some embodiments the network node 115, 116 further provides to any of the first, second and third base stations 111, 112, 113 the cell parameter used for offsetting the hand-over threshold.

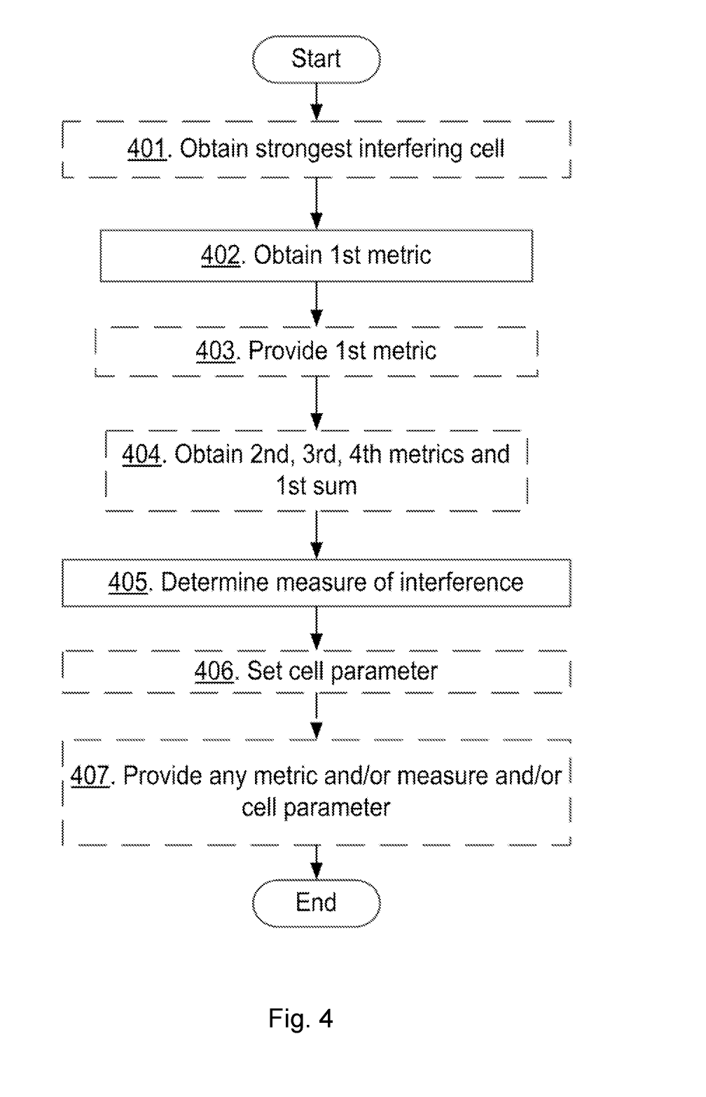

A method will now be described from a perspective of the network node 111, 115, 116 in a general way comprising both alternative methods described above. Thus, embodiments of a method in the network node 111, 115, 116 for determining the measure of the downlink interference in the wireless communications network 100, will be described with reference to a flowchart depicted in FIG. 4. As mentioned above, the first base station 111 communicates with the one or more first user equipments 121 in the first cell 131. Further, the downlink interference comprises the first interference in the one or more first user equipments 121.

The downlink interference may further comprise the second interference in the one or more second user equipments 122 in the second cell 132.

In some embodiments the downlink interference further comprises the third interference in the one or more third user equipments 123 in the third cell 133.

The downlink interference may further comprise the fourth interference in the one or more third user equipments 123 in the third cell 133. The method comprises the following actions, which actions may be taken in any suitable order.

Action 401

In order for the network node 111, 116 to be able to compile the information about the interference in the first cell 131 the network node 111, 116 may obtain from the one or more first user equipments 121 in the first cell 131, a respective information indicating a strongest interfering cell for the respective first user equipment 121. This action relates to actions 201 and 301 above.

Action 402

The network node 111, 115, 116 obtains a first metric representing a count of the second cell 132 as the strongest interfering cell for the one or more first user equipments 121 in the first cell 131 based on based on the respective information from the one or more first user equipments 121 in the first cell 131, which respective information indicates a strongest interfering cell for the respective first user equipment.

In some embodiments the network node 111, 116 is the first base station 111, and the obtaining the first metric is performed by computing the first metric based on the respective information from the one or more first user equipments 121 in the first cell 131.

When the network node 115, 116 is the central node 115, the first metric may be obtained from the first base station 111.

In some embodiments the network node 111, 115, 116 obtains the first metric by weighting each count of the second cell 132 as the strongest interfering cell with a weight. The weight may correspond to a property of the respective one or more first user equipment 121. The weight may further correspond to a signal power, associated with the interference, in the respective one or more first user equipment 121. This action relates to actions 202 and 303 above.

Action 403

When the network node 111, 116 have obtained the first metric, the network node 111, 116 may provide the first metric to the second base station 112. This action relates to action 203 above.

Action 404

In some embodiments the network node 111, 115, 116 obtains from the second base station 112, a second metric representing a count of the first cell 131 as the strongest interfering cell for the one or more second user equipments 122 in the second cell 132.

The network node 115, 116 may obtain the third metric from the third base station 113.

In some embodiments the network node 111, 115, 116 obtains from the third base station 113, a fourth metric. The fourth metric may represent a count of the first cell 131 as the strongest interfering cell for the one or more third user equipments 123 in the third cell 133.

The network node 111, 116 may further obtain from the second base station 112 a sum of the first metric and a third metric. The third metric may represent a count of the second cell 132 as the strongest interfering cell for the one or more third user equipments 123 in the third cell 133. This action relates to actions 203, 205 and 303 above.

Action 405

The network node 111, 115, 116 determines the measure of the downlink interference, at least based on the first metric. In the simplest case the determination of the downlink interference may be performed already after action 402.

The network node 111, 115, 116 may determine the measure of the downlink interference further based on the obtained second metric.

In some embodiments the network node 111, 115, 116 determines the measure of the downlink interference further based on the obtained first sum of the first and the third metrics.

The network node 111, 115, 116 may further determine the measure of the downlink interference based on the obtained fourth metric.

Further, the network node 111, 115, 116 may determine the measure of the downlink interference based on any sum and/or difference of the metrics. For example, the measure of the downlink interference may be based on a difference between the first sum and the second sum.

Further, the measure of the downlink interference may be normalized. This action relates to actions 206 and 304 above.

Action 406

After the network node 111, 115, 116 has determined the measure of the downlink interference the network node 111, 115, 116 may set the cell parameter used for offsetting the hand-over threshold between the first cell 131 and the second cell 132. The setting is based on the determined measure of the downlink interference. This action relates to action 207 and 305 above.

Action 407

In some embodiments the network node 111, 115, 116 provides to any of the first, second and third base stations 111, 112, 113 any one of the metrics.

The network node 111, 115, 116 may further provide to any of the first, second and third base stations 111, 112, 113 the measure of the downlink interference. In some embodiments the network node 111, 115, 116 further provides to any of the first, second and third base stations 111, 112, 113 the cell parameter used for offsetting the hand-over threshold. This action relates to action 306 above.

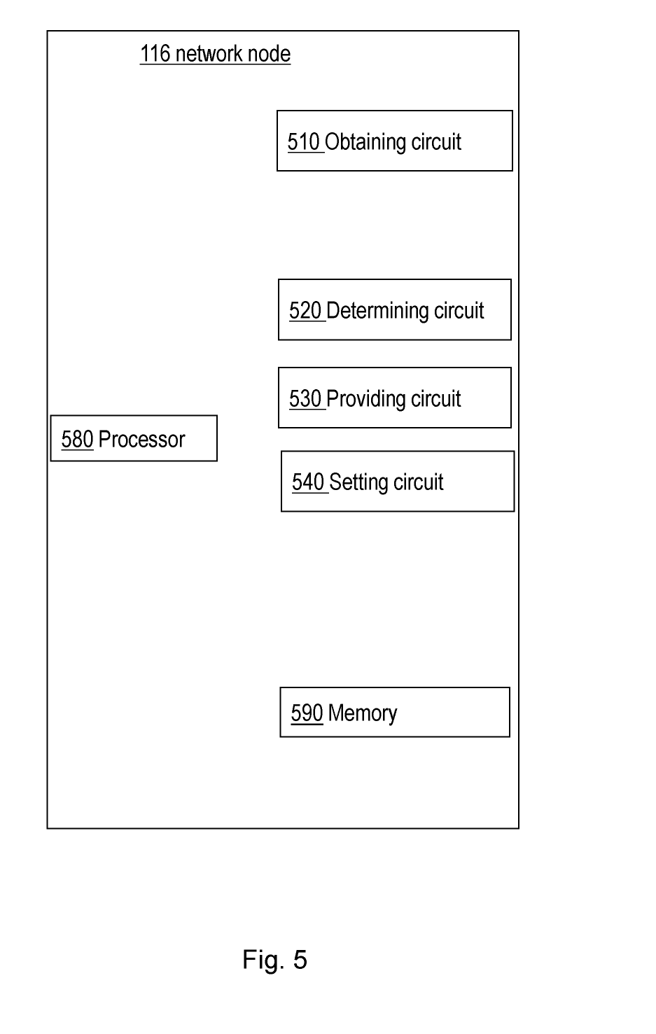

To perform the method actions for determining the measure of the downlink interference in the wireless communications network 100 described above in relation to FIG. 4, the network node 111, 115, 116 comprises the following arrangement depicted in FIG. 5. The network node 111, 115, 116 is configured to determine the measure of the downlink interference in the wireless communications network 100. As mentioned above, the network node 111, 115, 116 is arranged to communicate with the one or more first user equipments 121 in the first cell 131. Further, the downlink interference comprises the first interference in the one or more first user equipments 121.

The downlink interference may further comprise the second interference in the one or more second user equipments 122 in the second cell 132.

In some embodiments the downlink interference further comprises the third interference in the one or more third user equipments 123 in the third cell 133

The downlink interference may further comprise the fourth interference in the one or more third user equipments 123 in the third cell 133.

The network node 111, 115, 116 comprises an obtaining circuit 510. The obtaining circuit 510 is configured to obtain a first metric representing a count of the second cell 132 as the strongest interfering cell for the one or more first user equipments 121 in the first cell 131 based on the respective information from the one or more first user equipments 121 in the first cell 131.

When the network node 111, 116 is the first base station 111, the obtaining circuit 510 may further be configured to obtain the first metric by computing the first metric based on the respective information from the one or more first user equipments 121 in the first cell 131. The first metric may be the sum of the number of indications obtained from the one or more first user equipments 121.

In some embodiments the obtaining circuit 510 is further configured to obtain the first metric by weighting each count of the second cell 132 as the strongest interfering cell with the weight. The weight may correspond to the property of the respective one or more first user equipment 121. The weight may further correspond to the signal power, associated with the interference, in the respective one or more first user equipment 121. When the network node 115, 116 is a central node 115, the obtaining circuit 510 may further be configured to obtain the first metric from the first base station 111.

The obtaining circuit 510 may further be configured to obtain from the second base station 112 the second metric representing the count of the first cell 131 as the strongest interfering cell for the one or more second user equipments 122 in the second cell 132.

In some embodiments the obtaining circuit 510 is further configured to obtain from the second base station 112 the first sum of: the first metric and the third metric.

The obtaining circuit 510 may further be configured to obtain from the third base station 113 the fourth metric.

The network node 111, 115, 116 further comprises a determining circuit 520. The determining circuit 520 is configured to determine the measure of the downlink interference, based at least on the first metric.

The determining circuit 520 may be configured to determine the measure of the downlink interference further based on the obtained third metric.

In some embodiments the determining circuit 520 is configured to determine the measure of the downlink interference further based on the second metric.

The determining circuit 520 may be configured to determine the measure of the downlink interference further based on the obtained fourth metric.

In some embodiments the network node 111, 115, 116 determines the measure of the downlink interference based on the sum and/or the difference of the metrics.

Further, the measure of the downlink interference may be normalized.

The network node 111, 115, 116 may further comprise a providing circuit 530. The providing circuit 530 may be configured to provide to the second base station 112 the first metric.

The providing circuit 530 may be configured to provide to any of the first, second and third base stations 111, 112, 113 any one of the metrics.

In some embodiments the providing circuit 530 is further configured to provide to any of the first, second and third base stations 111, 112, 113 the measure of the downlink interference.

The providing circuit 530 may further be configured to provide to any of the first, second and third base stations 111, 112, 113 the cell parameter used for offsetting the hand-over threshold.

The network node 111, 115, 116 may further comprise a setting circuit 540. The setting circuit 540 may be configured to set the parameter used for offsetting the hand-over threshold between the first cell 131 and the second cell 132, based on the determined measure of the downlink interference.

The embodiments herein for determining the measure of the downlink interference in the wireless communications network 100 may be implemented through one or more processors, such as a processor 580 in the network node 111, 115, 116 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the in the network node 111, 115, 116. One such carrier may be in the form of a CD ROM disc. It is however feasible with other data carriers such as a memory stick. The computer program code may furthermore be provided as pure program code on a server and downloaded to the network node 111, 115, 116.

The network node 111, 115, 116 may further comprise a memory 590 comprising one or more memory units. The memory 590 is arranged to be used to store indications, metrics, determined measures of the downlink interference, cell parameters, configurations, and applications to perform the methods herein when being executed in the network node 111, 115, 116.

Those skilled in the art will also appreciate that the obtaining circuit 510, determining circuit 520, providing circuit 530, and setting circuit 540 described above may refer to a combination of analog and digital circuits, and/or one or more processors configured with software and/or firmware, e.g. stored in a memory, that when executed by the one or more processors such as the processor 580 perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

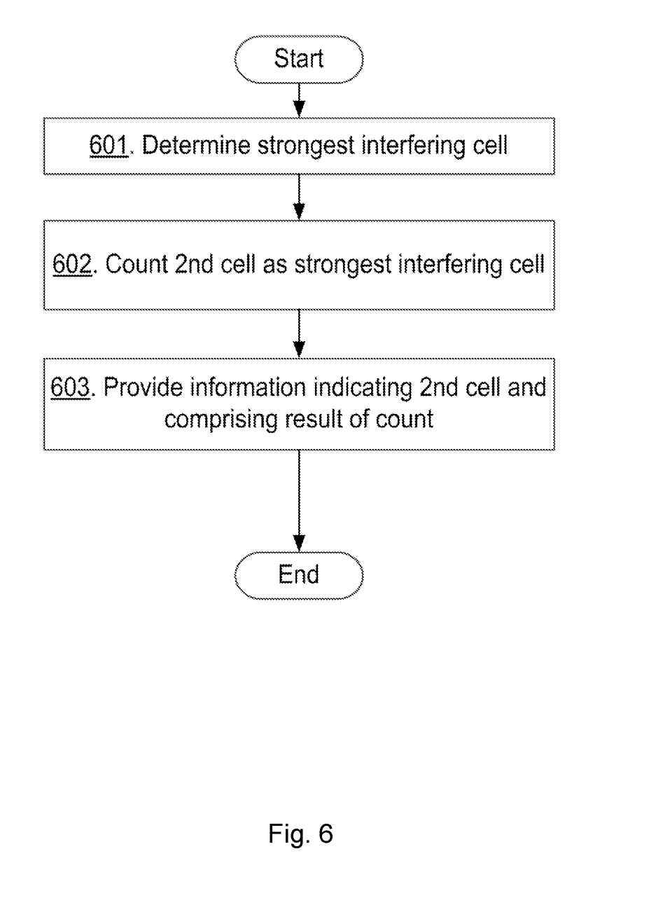

A method will now be described from a perspective of one of the one or more first user equipments 121. Thus, embodiments of a method in the one or more first user equipments 121 for assisting the network node 111, 115, 116 in determining a measure of a downlink interference in the wireless communications network 100, will now be described with reference to a flowchart depicted in FIG. 6. As mentioned above, the first base station 111 communicates with the one or more first user equipments 121 in the first cell 131. Further, the downlink interference comprises the first interference in the one or more first user equipments 121.

Action 601

The one or more first user equipments 121 determines a strongest interfering cell. This action relates to action 201 and action 301 above.

Action 602

The one or more first user equipments 121 counts the second cell 132 as the strongest interfering cell for the first user equipment 121. The one or more first user equipments 121 may summarize the counts for the second cell 132 during a specific time period. The specific time period may for example be the time period during which the one or more first user equipments 121 communicates with the serving first base station 111. This action relates to 201 and 301 above.

Action 603

The one or more first user equipments 121 assists the network node 111, 115, 116 in determining the measure of the downlink interference by providing to the network node 111, 115, 116 an information indicating the second cell 132 as the strongest interfering cell for the first user equipment 121. The information comprises a result of the counting. This action relates to action 201 and 301 above.

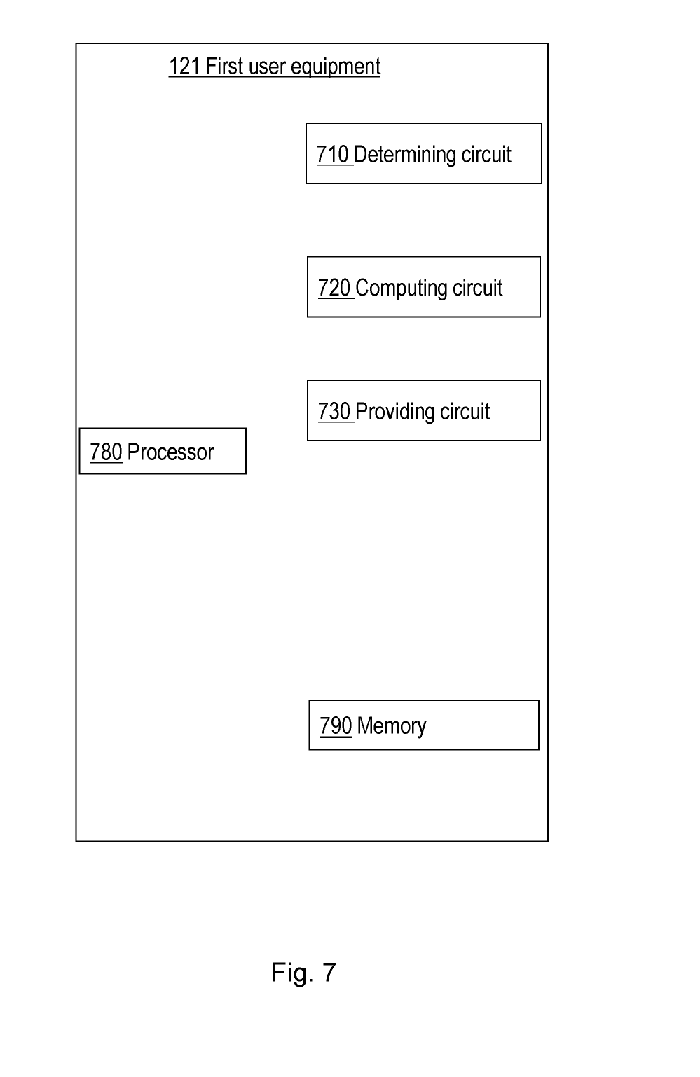

To perform the method actions for assisting the network node 111, 115, 116 in determining a measure of a downlink interference in the wireless communications network 100 described above in relation to FIG. 6, the one or more first user equipments 121 comprises the following arrangement depicted in FIG. 7. The one or more first user equipments 121 is configured to assist the network node 111, 115, 116 in determining a measure of a downlink interference.

As mentioned above, the first user equipment 121 is arranged to be located in a first cell 131, and arranged to communicate with a first base station 111.

Further, the downlink interference comprises the first interference in the one or more first user equipments 121.

The one or more first user equipments 121 comprises an determining circuit 710. The determining circuit 710 is configured to determine a strongest interfering cell.

The one or more first user equipments 121 comprises an counting circuit 720. The counting circuit 710 is configured to count the second cell 132 as the strongest interfering cell for the first user equipment 121.

The one or more first user equipments 121 comprises an providing circuit 730. The providing circuit 730 is configured to assist the network node 111, 115, 116 in determining the measure of the downlink interference by providing to the network node 111, 115, 116 an information indicating the second cell 132 as the strongest interfering cell for the first user equipment 121, which information comprises the count of the second cell 132 as the strongest interfering cell for the first user equipment 121.

The embodiments herein for assisting the network node 111, 115, 116 in determining the measure of the downlink interference in the wireless communications network 100 may be implemented through one or more processors, such as a processor 780 in the one or more first user equipments 121 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the one or more first user equipments 121. One such carrier may be in the form of a CD ROM disc. It is however feasible with other data carriers such as a memory stick. The computer program code may furthermore be provided as pure program code on a server and downloaded to the one or more first user equipments 121.

The one or more first user equipments 121 may further comprise a memory 790 comprising one or more memory units. The memory 790 is arranged to be used to store indications, metrics, determined measures of the downlink interference, cell parameters, configurations, and applications to perform the methods herein when being executed in the one or more first user equipments 121.

Those skilled in the art will also appreciate that the determining circuit 710, counting circuit 720 and providing circuit 730 described above may refer to a combination of analog and digital circuits, and/or one or more processors configured with software and/or firmware, e.g. stored in a memory, that when executed by the one or more processors such as the processor 780 perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1. A method in a network node for determining a measure of a downlink interference in a wireless communications network, and which downlink interference comprises a first interference in one or more first user equipments in a first cell served by a first base station, which respective interference in the one or more first user equipments originates from a second base station when the second base station communicates with one or more second user equipments in a second cell, the method comprising:
obtaining a first metric representing a count of the second cell as the strongest interfering cell for the one or more first user equipments in the first cell based on a respective information from the one or more first user equipments in the first cell, which respective information indicates a strongest interfering cell for the respective first user equipment, and
determining a measure of the downlink interference, based on the first metric.

2. The method according to claim 1, wherein the downlink interference further comprises a second interference in the one or more second user equipments in the second cell, and which respective second interference originates from the first base station when communicating with the one or more first user equipments in the first cell, the method further comprising:
obtaining from the second base station a second metric representing a count of the first cell as the strongest interfering cell for the one or more second user equipments in the second cell, and
wherein the determining the measure of the downlink interference further is based on the second metric.

3. The method according to claim 1, wherein the downlink interference further comprises a third interference in one or more third user equipments in a third cell, which one or more third user equipments communicates with a third base station in the wireless communications system, and which respective third interference originates from the second base station when communicating with the one or more second user equipments in the second cell, the method further comprising:
providing to the second base station the first metric, and
obtaining from the second base station a first sum of: the first metric and a third metric representing a count of the second cell as the strongest interfering cell for the one or more third user equipments in the third cell, and
wherein the determining the measure of the downlink interference, further is based on the obtained third metric.

4. The method according to claim 1, wherein the downlink interference further comprises the third interference in the one or more third user equipments in the third cell, the method further comprising:
obtaining from the third base station the third metric representing a count of the second cell as the strongest interfering cell in the third cell, and
wherein the determining the measure of the downlink interference, further is based on the obtained third metric.

5. The method according to claim 1, wherein the downlink interference further comprises a fourth interference in the one or more third user equipments in the third cell, which one or more third user equipments communicates with the third base station, and which respective fourth interference originates from the first base station when communicating with the one or more first user equipments in the first cell, the method further comprising:
obtaining from the third base station a fourth metric representing a count of the first cell as the strongest interfering cell for the one or more third user equipments in the third cell, and
wherein the determining the measure of the downlink interference further is based on the obtained fourth metric.

6. The method according to claim 1, wherein the network node is the first base station, and the obtaining the first metric is performed by computing the first metric based on the respective information from the one or more first user equipments in the first cell.

7. The method according to claim 1, wherein the network node is a central node, and the first metric is obtained from the first base station.

8. The method according to claim 1, wherein the obtaining the first metric of the count of the second cell as the strongest interfering cell comprises weighting each count of the second cell as the strongest interfering cell with a weight corresponding to a property of the respective one or more first user equipment and/or corresponding to a signal power, associated with the interference, in the respective one or more first user equipment.

9. The method according to claim 1, further comprising setting a cell parameter used for offsetting a hand-over threshold between the first cell and the second cell, based on the determined measure of the downlink interference.

10. The method according to claim 1, further comprising providing to any of the first, second and third base stations any one of the metrics and/or the measure of the downlink interference and/or the cell parameter used for offsetting the hand-over threshold.

11. A network node configured to determine a measure of a downlink interference in a wireless communications network, which downlink interference comprises a first interference in one or more first user equipments in a first cell arranged to be served by a first base station, which respective interference in the one or more first user equipments originates from a second base station when the second base station communicates with one or more second user equipments in a second cell, the network node comprising:
an obtaining circuit configured to obtain a first metric representing a count of the second cell as the strongest interfering cell for the one or more first user equipments in the first cell based on a respective information from the one or more first user equipments in the first cell, which respective information indicates a strongest interfering cell for the respective first user equipment, and
a determining circuit configured to determine a measure of the downlink interference, based on the first metric.

12. The network node according to claim 11, wherein the downlink interference further comprises a second interference in the one or more second user equipments in the second cell, and which respective second interference originates from the first base station when communicating with the one or more first user equipments in the first cell, and wherein the obtaining circuit further is configured to obtain from the second base station a second metric representing a count of the first cell as the strongest interfering cell for the one or more second user equipments in the second cell, and wherein the determining circuit further is configured to determine the measure of the downlink interference based on the second metric.

13. The network node according to claim 11, wherein the downlink interference further comprises a third interference in one or more third user equipments in a third cell, which one or more third user equipments are arranged to communicate with a third base station in the wireless communications system, and which respective third interference originates from the second base station when communicating with the one or more second user equipments in the second cell, further comprising a providing circuit configured to provide to the second base station the first metric, and wherein the obtaining circuit further is configured to obtain from the second base station a first sum of: the first metric and a third metric representing a count of the second cell as the strongest interfering cell for the one or more third user equipments in the third cell, and wherein the determining circuit further is configured to determine the measure of the downlink interference based on the third metric.

14. The network node according to claim 11, wherein the downlink interference further comprises the third interference in the one or more third user equipments in the third cell, and wherein the obtaining circuit further is configured to obtain from the third base station a third metric representing a count of the second cell as the strongest interfering cell for the one or more third user equipments in the third cell, and wherein the determining circuit further is configured to determine the measure of the downlink interference based on the third metric.

15. The network node according to claim 11, wherein the downlink interference further comprises a fourth interference in the one or more third user equipments in the third cell, which one or more third user equipments are arranged to communicates with the third base station, and which respective fourth interference originates from the first base station when communicating with the one or more first user equipments in the first cell, wherein the obtaining circuit further is configured to obtain from the third base station a fourth metric representing a count of the first cell as the strongest interfering cell for the one or more third user equipments in the third cell, and wherein the determining circuit further is configured to determine the measure of the downlink interference based on the fourth metric.

16. The network node according to claim 11, wherein the network node is the first base station, and the obtaining circuit is further configured to obtain the first metric by computing the first metric based on the respective information from the one or more first user equipments in the first cell.

17. The network node according to claim 11, wherein the network node is a central node, and the obtaining circuit is further configured to obtain the first metric from the first base station.

18. The network node according to claim 11, wherein the obtaining circuit further is configured to obtain the first metric by weighting each count of the second cell as the strongest interfering cell with a weight corresponding to a property of the respective one or more first user equipment and/or corresponding to a signal power, associated with the interference, in the respective one or more first user equipment.

19. The network node according to claim 11, further comprising a setting circuit configured to set a cell parameter used for offsetting a hand-over threshold between the first cell and the second cell, based on the determined measure of the downlink interference.

20. The network node according to claim 11, wherein the providing circuit further is configured to provide to any of the first, second and third base stations any one of the metrics and/or the measure of the downlink interference and/or the cell parameter used for offsetting the hand-over threshold.

21. A method in a first user equipment for assisting a network node in determining a measure of a downlink interference in a wireless communications network, which first user equipment is located in a first cell, and communicates with a first base station, and which downlink interference comprises an interference in the first user equipment originating from a second base station when the second base station communicates with one or more second user equipments in a second cell, the method comprising:
determining a strongest interfering cell,
counting the second cell as the strongest interfering cell for the first user equipment, and
assisting the network node in determining the measure of the downlink interference by providing to the network node an information indicating the second cell as the strongest interfering cell for the first user equipment, which information comprises a result of the counting.

22. A first user equipment configured to assist a network node in determining a measure of a downlink interference in a wireless communications network, which first user equipment is arranged to be located in a first cell, and arranged to communicate with a first base station, and which downlink interference comprises an interference in the first user equipment originating from a second base station when the second base station communicates with one or more second user equipments in a second cell, the first user equipment comprising:
a determining circuit configured to determine a strongest interfering cell,
a counting circuit configured to count the second cell as the strongest interfering cell for the first user equipment, and
a providing circuit configured to assist the network node in determining the measure of the downlink interference by providing to the network node an information indicating the second cell as the strongest interfering cell for the first user equipment, which information comprises the count of the second cell as the strongest interfering cell for the first user equipment.
